(19) United States
(12) Patent Application Publication
(10) Pub. No.: US 2025/0230890 A1
(43) Pub. Date: Jul. 17, 2025

(54) ADDITIVE MANUFACTURED RETURN BEND FOR FIRE TUBE OR FURNACE TUBE

(71) Applicant: Chevron U.S.A. Inc., San Ramon, CA (US)

(72) Inventors: Jonathan Isaac Garcia, Sugar Land, TX (US); Mason Michael Kinter, El Segundo, CA (US); Jaan Taagepera, Benicia, CA (US)

(21) Appl. No.: 19/016,651

(22) Filed: Jan. 10, 2025

Related U.S. Application Data
(60) Provisional application No. 63/620,405, filed on Jan. 12, 2024.

(51) Int. Cl. F16L 43/00; B33Y 80/00; F28F 1/42

(52) U.S. Cl. CPC F16L 43/005; B33Y 80/00; F28F 1/422; F28F 2001/428

(57) ABSTRACT

A return bend for use in a heater treater, production separator, or furnace is designed to join adjacent tubes. The return bend includes a pipe constructed in a continuous piece. The pipe includes: a first end forming a first opening of the pipe facing a first direction; a second end opposite the first end, the second end forming a second opening facing the first direction; and at least one curving section that bends with a continuously smooth curvature of the pipe wall from the first end to the second end.

### CROSS REFERENCE TO RELATED APPLICATION

This patent application claims priority to and the benefit of U.S. Provisional Patent Application No. 63/620,405, filed on Jan. 12, 2024, which is incorporated by reference herein in its entirety.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Fire tubes in heater treater and product separator applications and/or furnace tubes generally consist of one tube or pipe connected to another parallel tube or pipe by a return bend. Such applications are relatively unique in that the size of such fire tubes necessitates very specific manufacturing requirements. For instance, the center-center distance between the parallel tubes or pipes is typically too small to permit the use of a standard short-radius return bend to connect the tubes.

In current practice, the two tubes are usually connected using mitered bends. The welds of the miter joints are subject to high levels of stress and are prone to failure. The mitered bends are also difficult to weld or inspect, particularly at the “intrados” (the inside of the bend) where access is limited. An example of such a configuration is shown in FIG. 1 where a fire tube 100 has a return bend 102 with multiple miter joints 104.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with aspects of the disclosure, a return bend for use in a heater treater, production separator, or furnace and designed to join adjacent tubes, the return bend including: a pipe constructed in a continuous piece, the pipe having: a first end forming a first opening of the pipe facing a first direction; a second end opposite the first end, the second end forming a second opening facing the first direction; and at least one curving section that bends with a continuously smooth curvature of the pipe wall from the first end to the second end.

In accordance with other aspects of the disclosure, a heater treater or production separator having a pair of parallel fire tubes joined by a return bend, the return bend including: a pipe constructed in a continuous piece, the pipe having: a first end forming a first opening of the pipe facing a first direction; a second end opposite the first end, the second end forming a second opening facing the first direction; and at least one curving section that bends with a continuously smooth curvature of the pipe wall from the first end to the second end.

In accordance with other aspects of the disclosure, a process includes using additive manufacturing to form a return bend, the return bend including: a pipe constructed in a continuous piece, the pipe having: a first end forming a first opening of the pipe facing a first direction; a second end opposite the first end, the second end forming a second opening facing the first direction; and at least one curving section that bends with a continuously smooth curvature of the pipe wall from the first end to the second end.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 is a side view of a fire tube having a return bend formed using traditional techniques.

FIG. 2 is a side view of a fire tube having an additive manufactured return bend, in accordance with an embodiment of the present disclosure.

FIG. 3 is a perspective view of an additive manufactured return bend, in accordance with an embodiment of the present disclosure.

FIG. 4 is a cross-sectional view of the additive manufactured return bend of FIG. 3, in accordance with an embodiment of the present disclosure.

FIGS. 5A and 5B are perspective and cutaway views of an additive manufactured return bend with a non-circular cross-section, in accordance with an embodiment of the present disclosure.

FIGS. 6A and 6B are perspective and cutaway views of another additive manufactured return bend with a non-circular cross-section, in accordance with an embodiment of the present disclosure.

FIGS. 7A and 7B are perspective and cutaway views of an additive manufactured return bend with varying wall thickness, in accordance with an embodiment of the present disclosure.

FIGS. 8A and 8B are perspective and cutaway views of an additive manufactured return bend with interior fins, in accordance with an embodiment of the present disclosure.

FIGS. 9A and 9B are perspective and cutaway views of an additive manufactured return bend with exterior fins, in accordance with an embodiment of the present disclosure.

### DETAILED DESCRIPTION OF THE INVENTION

In accordance with the present embodiments, a welded return bend for a fire tube heater treater and production separator and/or furnace tube is replaced by a return bend formed using additive manufacturing. An additive manufacturing process of this disclosure includes creating return bends that are customized to address the size requirements and harsh conditions in which fire tubes or furnace tubes are deployed. Instead of being confined by the limitations of conventional approaches in which such large fire tubes are formed by connecting (e.g., welding) mitered bends, the additive manufacturing process of this disclosure results in a layered assembly of materials that provides advantages when applied to the large, curved features of return bends. Because the additive manufacturing process of this disclosure eliminates the need to connect mitered features (e.g., providing a one-piece return bend with no welded seams), it may eliminate or greatly reduce the stress concentrations introduced by conventional manufacturing by welding miter joints.

Furthermore, additive manufacturing allows for the use of unique shapes and materials in creating durable return bends. As one example, the return bends can be made thicker in vulnerable areas and/or or can be made from a variety of materials. In certain embodiments, the return bends may be formed with a functional gradient wherein a cross-section of the return bend comprises different materials or has different properties along the cross-section. Some of the materials may have different corrosion resistance, different heat capacities, and so forth. These return bends with variable thicknesses and/or made from different materials can improve the fatigue performance, corrosion resistance, and/or erosion resistance of the return bend as compared to mitered return bends.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

As shown in FIG. 2, a fire tube 200 produced in accordance with the present disclosure includes parallel straight tube portions 202 connected via a return bend 204 that has no mitered bends. In other words, the return bend 204 is smooth, and contains no edges or corners along its curved radius. The return bend 204 is a one-piece return with no welded seams. Although two straight tube portions 202 are shown, a similar additive manufactured return bend 204 may be used to connect two tube portions having any desired shape and/or configuration. For example, the disclosed return bend 204 may be used to connect two tube portions that are not straight, or one straight tube portion to one non-straight tube portion. The present disclosure is not limited to the use with fire tubes 200, but rather the disclosed return bend 204 may similarly be used with smaller diameter furnace tubes.

In some embodiments, using additive manufacturing allows an evolution of the traditional short-radius (one pipe diameter distance as the centerline turn radius) return bend to have an even shorter radius. That is, the return bend 204 may have a centerline turn radius that is less than one pipe (less than one tube) diameter distance. Common tube diameters range from NPS 8 to NPS 36. Thus, in some embodiments a return bend of the present disclosure connected to a tube with a diameter of NPS 8 may have a centerline turn radius of less than NPS 8, a return bend of the present disclosure connected to a tube with a diameter of NPS 36 may have a centerline turn radius of less than NPS 36, and so on.

The return bend 204 may be constructed as a continuous piece. In some embodiments, the return bend 204 may be a continuous piece of the same material. The material of construction for the return bend 204 may include, for example, carbon steel, or other higher metallurgy materials (e.g. low chrome alloys or stainless steel). The return bend 204 may include the continuous piece of material constructed via additive manufacturing, and the continuous piece may be coated on the inside with one or more additional materials.

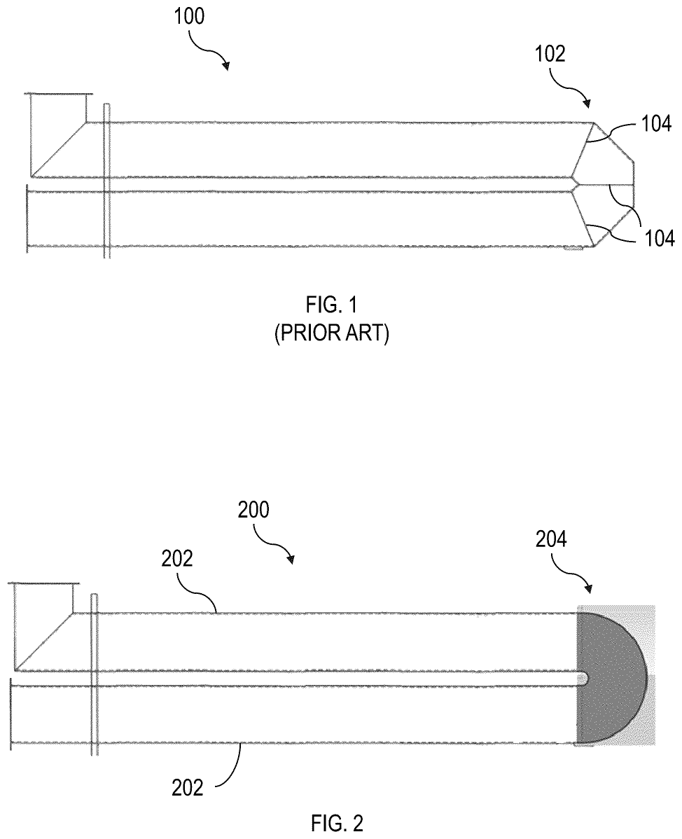

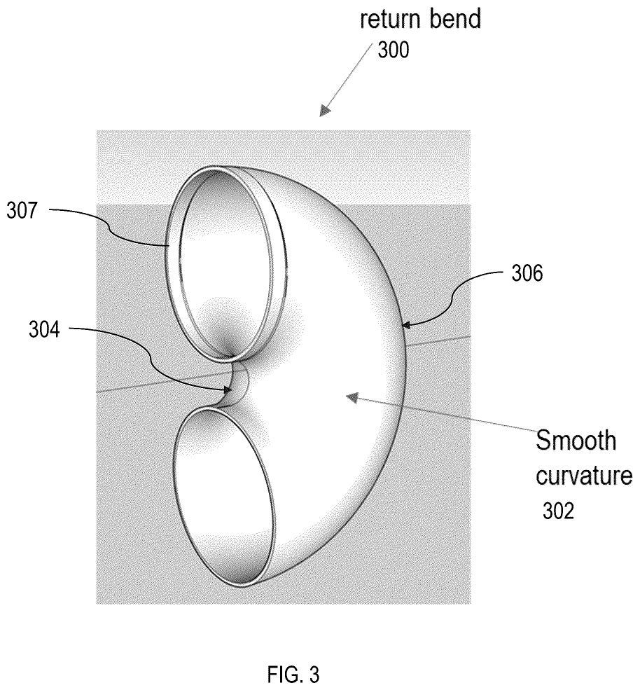

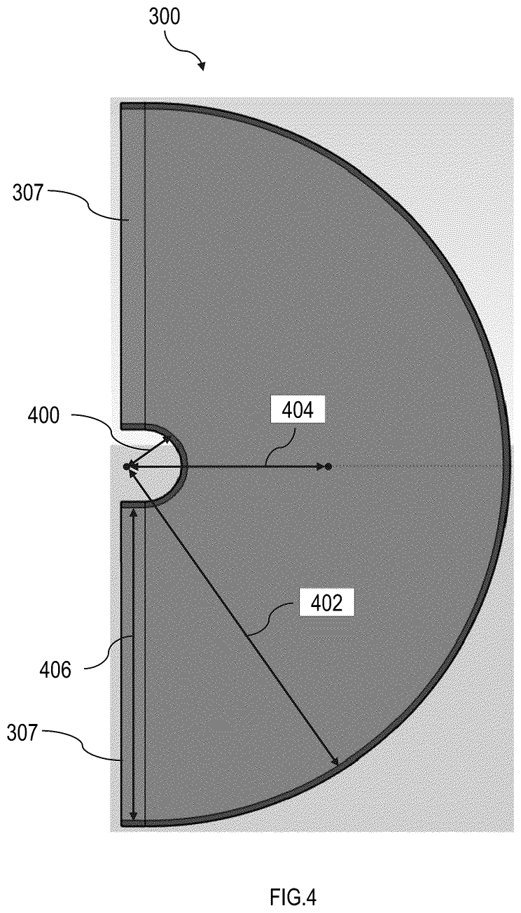

The smooth radius design eliminates the failure-prone stress concentrations that can occur in the mitered/segmented bends (104 of FIG. 1) in the current art and overcomes the dimensional limitations of standard fabricated short and long radius return bends. More detailed views of an example return bend 300 are shown in FIGS. 3 and 4. FIG. 3 shows that the return bend 300 may have a smooth external surface 302 along its entire bend section, reducing stress concentrations along the intrados 304 of the return bend (as compared to traditional mitered return bends).

FIG. 4 shows a cross-section of the return bend 300 of FIG. 3 with certain dimensions indicated. In the illustrated embodiment, the return bend 300 has an inner turn radius 400 at its intrados 304 of approximately 6 inches and an outer turn radius 402 at its extrados 306 of approximately 30 inches. As such, a centerline turn radius 404 of the return bend 300 would be 18 inches while the diameter 406 of the return bend 300 is 24 inches. This is one example of how additive manufacturing allows for construction of a return bend 300 having a centerline turn radius 404 (18 inches) that is less than the one diameter (406) length (24 inches). The dimensions discussed with respect to FIG. 4 are exemplary, and other dimensions of return bends 300 having a centerline turn radius 404 that is less than one diameter (406) length may be constructed via additive manufacturing.

FIGS. 3, 4, and 7A-9B show return bends having one or more straight flanges 307 at an end thereof for connecting the return bend to straight tube portions. However, other embodiments of the return bend may not include any straight flanges 307. Although the two straight flanges 307 at opposing ends of the return bend 300 shown in FIG. 4 have the same length in a direction parallel to the axis of the tube, in other embodiments different ends of the same return bend may have straight flanges of differing lengths from each other in this axial direction.

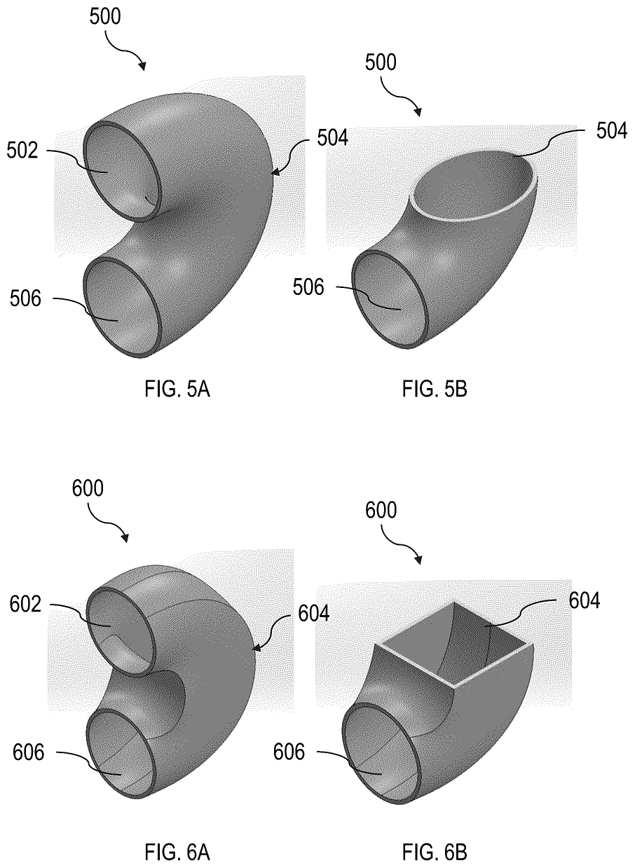

The example return bend 300 shown in FIGS. 3 and 4 has a substantially uniform circular cross section. However, the disclosed additive manufacturing process may produce return bends having any desired cross section. In addition, the disclosed additive manufacturing process may produce return bends having a variable cross section. As an example, FIGS. 5A, 5B, 6A, and 6B show other examples of return bends 500, 600 that may be constructed using additive manufacturing having at least a portion of the return bend with a non-circular cross section. FIGS. 5A and 5B show an example return bend 500 built from additive manufacturing having a circular cross section at its first end 502, an oval cross section at a central portion 504 along its length, and a circular cross section at its second end 506 opposite the first end. FIGS. 6A and 6B show an example return bend 600 built from additive manufacturing having a circular cross section at its first end 602, a rectangular (e.g., square) cross section at a central portion 604 along its length, and a circular cross section at its second end 606 opposite the first end. In both cases, using additive manufacturing may enable a smooth transition of the cross section between the circular and non-circular sections of the return bend 500, 600. In other embodiments, the cross section of the return bend may remain circular along its length but exhibit a change in diameter of its circular cross section along the length of the bend (e.g., from a first diameter at one end to a second, different diameter at a central portion along its length, and then back to the first diameter at its opposite end). Using additive manufacturing may enable a smooth transition of the cross section between different sections of the return bend.

In certain embodiments, as shown in FIGS. 3, 5A, 5B, 6A, and 6B, when viewed in a direction perpendicular to the cross section of the return bend 300, 500, 600, the wall(s) of the return bend may have a uniform thickness along the perimeter of the return bend cross section. Similarly, the wall(s) of the return bend may have a uniform thickness at different locations along the length of the return bend.

In other embodiments, one or more portions of the wall(s) of the return bend may have a different thickness than the rest of the wall(s) to provide beneficial stress management properties to the return bend. The one or more portions with a different thickness may be at certain locations along the length of the return bend, at certain locations along the perimeter of the return bend, or both. The wall(s) of the return bend may vary widely in thickness along different longitudinal and/or circumferential portions of the return bend to provide desired performance characteristics. Additive manufacturing of the return bend may provide such variations in thickness of the return bend.

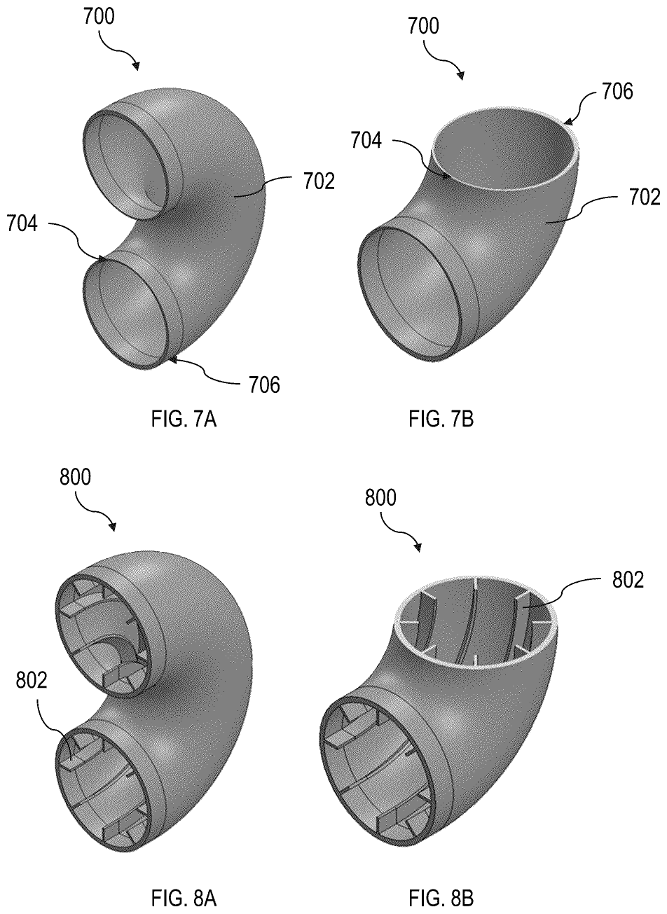

FIGS. 7A and 7B illustrate one such example of a return bend 700 having a variable wall thickness. In particular, the wall 702 of the return bend of FIGS. 7A and 7B is thinner along the intrados 704 of the return bend 700 and thicker along the extrados 706 of the return bend 700. The relative thickness along the wall 702 of the return bend 700 may impact the stiffness of the part. The wall thickness of the return bend 700 may be varied as such to improve the fatigue performance of the return bend 700. As shown in FIGS. 7A and 7B, the wall thickness may vary gradually and smoothly around the perimeter of the return bend (e.g., from the intrados 704 around to the extrados 706). Using additive manufacturing may enable a smooth transition of the wall thickness between different portions of the return bend 700.

In certain embodiments, as shown in FIGS. 3-7B, the return bend 300, 500, 600, 700 may have a substantially smooth outer surface and a substantially smooth inner surface. In other embodiments, the return bend may be constructed with fins, ridges, slots, or other surface textures formed along the outer surface of the return tube, the inner surface of the return tube, or both. The disclosed additive manufacturing process may be used to provide such different surface features or textures on the return bend. The use of fins and other surface features may increase heat transfer of the return bend compared to existing mitered bends, potentially making the heater treater/production separator/furnace more efficient.

As an example, FIGS. 8A and 8B illustrate a return bend 800 with fins 802 formed along its inner diameter. The illustrated fins 802 extend radially inward from the inner diameter of the return bend 800, and they follow the longitudinal direction of the return bend 800. The fins 802 may be spaced equidistantly from each other about a circumference of the return bend 800, as shown. It should be noted that other variations of interior fins 802 may be used in other embodiments of the return bend 800. For example, the return bend 800 may be constructed with interior fins 802 that follow a circumferential direction of the return bend, rather than a longitudinal direction, or a combination of both circumferential and longitudinal directions (e.g., helically arranged). The interior fins 802 may have any desirable size, shape, and/or configuration with respect to the return bend body. The interior fins 802 may be integral with the rest of the return bend 800, being built into the return bend 800 during the initial constructions process using additive manufacturing. The interior fins 802 may change the heat transfer through the return bend 800.

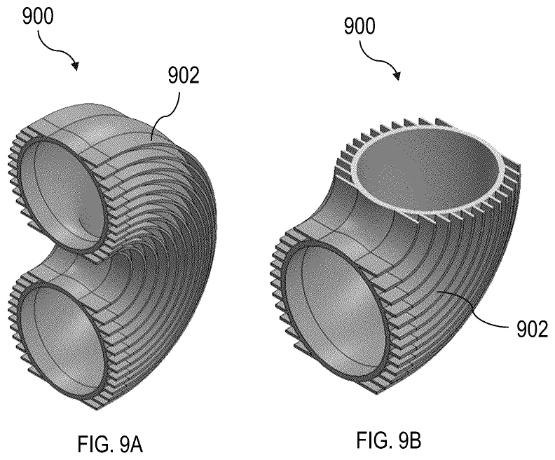

As another example, FIGS. 9A and 9B illustrate a return bend 900 with fins 902 formed along its outer diameter. The illustrated fins 902 extend outward, parallel to each other, in a width direction (e.g., a horizontal direction) from the outer diameter of the return bend 900, and they follow the longitudinal direction of the return bend 900. The fins 902 may be spaced equidistantly from each other in a direction (e.g., vertical direction) perpendicular to the width direction, as shown. It should be noted that other variations of exterior fins 902 may be used in other embodiments of the return bend 900. For example, the return bend 900 may be constructed with exterior fins 902 that extend in radially outward directions from the return bend 900, rather than parallel to each other in a width direction. The return bend 900 may be constructed with exterior fins 902 that follow a circumferential direction of the return bend, rather than a longitudinal direction, or a combination of both circumferential and longitudinal directions (e.g., helically arranged). The exterior fins 902 may have any desirable size, shape, and/or configuration with respect to the return bend body 900. The exterior fins 902 may be integral with the rest of the return bend 900, being built into the return bend 900 during the initial constructions process using additive manufacturing. The exterior fins 902 may change the heat transfer to or from the return bend 900.

### Illustrative Embodiments are Listed Below

Embodiment 1: A return bend for use in a heater treater, production separator, or furnace and designed to join adjacent tubes, the return bend including: a pipe constructed in a continuous piece, the pipe having: a first end forming a first opening of the pipe facing a first direction; a second end opposite the first end, the second end forming a second opening facing the first direction; and at least one curving section that bends with a continuously smooth curvature of the pipe wall from the first end to the second end.

Embodiment 2: The return bend of Embodiment 1, wherein the pipe has a centerline turn radius that is less than one pipe diameter distance of the pipe.

Embodiment 3: The return bend of Embodiment 1, wherein the pipe has a circular cross section along its entire length from the first end to the second end.

Embodiment 4: The return bend of Embodiment 1, wherein the pipe has a first cross section at both the first end and the second end of the pipe and a second cross section different from the first cross section at a central portion of the pipe between the first end and the second end.

Embodiment 5: The return bend of Embodiment 4, wherein the first cross section is a circular cross section, and the second cross section is a non-circular cross section.

Embodiment 6: The return bend of Embodiment 1, wherein the pipe has no mitered edge.

Embodiment 7: The return bend of Embodiment 1, wherein the pipe has a variable wall thickness.

Embodiment 8: The return bend of Embodiment 1, wherein the pipe has interior fins formed thereon, the fins extending inward from a radially inner surface of the pipe, the interior fins being integral with the rest of the pipe.

Embodiment 9: The return bend of Embodiment 1, wherein the pipe has exterior fins formed thereon, the fins extending outward from a radially outer surface of the pipe, the exterior fins being integral with the rest of the pipe.

Embodiment 10: The return bend of Embodiment 1, wherein the pipe is a continuous piece of the same material.

Embodiment 11: A heater treater or production separator having a pair of parallel fire tubes joined by a return bend including: a pipe constructed in a continuous piece, the pipe having: a first end forming a first opening of the pipe facing a first direction; a second end opposite the first end, the second end forming a second opening facing the first direction; and at least one curving section that bends with a continuously smooth curvature of the pipe wall from the first end to the second end.

Embodiment 12: A process including using additive manufacturing to form a return bend including: a pipe constructed in a continuous piece, the pipe having: a first end forming a first opening of the pipe facing a first direction; a second end opposite the first end, the second end forming a second opening facing the first direction; and at least one curving section that bends with a continuously smooth curvature of the pipe wall from the first end to the second end.

It will be understood that various modifications may be made to the embodiments disclosed herein. Therefore, the above description should not be construed as limiting, but merely as exemplifications of example embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

1. A return bend for use in a heater treater, production separator, or furnace and designed to join adjacent tubes, the return bend comprising:
a pipe constructed in a continuous piece, the pipe having:
a first end forming a first opening of the pipe facing a first direction;
a second end opposite the first end, the second end forming a second opening facing the first direction; and
at least one curving section that bends with a continuously smooth curvature of the pipe wall from the first end to the second end.

2. The return bend of claim 1, wherein the pipe has a centerline turn radius that is less than one pipe diameter distance of the pipe.

3. The return bend of claim 1, wherein the pipe has a circular cross section along its entire length from the first end to the second end.

4. The return bend of claim 1, wherein the pipe has a first cross section at both the first end and the second end of the pipe and a second cross section different from the first cross section at a central portion of the pipe between the first end and the second end.

5. The return bend of claim 4, wherein the first cross section is a circular cross section, and the second cross section is a non-circular cross section.

6. The return bend of claim 1, wherein the pipe has no mitered edge.

7. The return bend of claim 1, wherein the pipe has a variable wall thickness.

8. The return bend of claim 1, wherein the pipe has interior fins formed thereon, the fins extending inward from a radially inner surface of the pipe, the interior fins being integral with the rest of the pipe.

9. The return bend of claim 1, wherein the pipe has exterior fins formed thereon, the fins extending outward from a radially outer surface of the pipe, the exterior fins being integral with the rest of the pipe.

10. The return bend of claim 1, wherein the pipe is a continuous piece of the same material.

11. A heater treater or production separator having a pair of parallel fire tubes joined by the return bend of claim 1.

12. A process comprising using additive manufacturing to form the return bend of claim 1.
